(19) United States
(12) Patent Application Publication
(10) Pub. No.: US 2025/0283534 A1
(43) Pub. Date: Sep. 11, 2025

(54) Metallic Dynamic Seal

(71) Applicant: Batfer Investment S.A., Montevideo (UY)

(72) Inventors: Claudine Costa Dos Reis, Taubate (BR); Alexandre Julio Marcondes, Rio de Janeiro (BR)

(21) Appl. No.: 19/068,187

(22) Filed: Mar. 3, 2025

(30) Foreign Application Priority Data
Mar. 6, 2024 (BR) 102024004480-0

(51) Int. Cl. F16J 15/08

(52) U.S. Cl. CPC F16J 15/0887

(57) ABSTRACT

A dynamic seal comprising an annular main body comprising an axial axis, an external perimeter surface and an internal perimeter surface, said internal perimeter surface comprising at least two convex contact surfaces configured to define a metal-to-metal sealing region, and where the external surface comprises at least two concave surfaces corresponding to said respective convex contact surfaces separated by a flange projecting radially outward from the axial axis of said annular main body.

### CROSS-REFERENCE TO RELATED APPLICATION

This application claims priority to Brazilian application BR 102024004480-0 filed on Mar. 6, 2024, the disclosure of which is incorporated herein by reference for all purposes.

### SPECIFICATION

The present invention relates to a metallic dynamic seal that provides a metal-to-metal scaling region, with high sealing efficiency and that is particularly designed to withstand harsh environmental conditions such as high pressures, high temperatures and corrosive environments.

The dynamic seal according to the present invention can be energized by pressure action to maintain fluid integrity and is particularly useful in maritime industries, such as in subsea oil drilling.

Therefore, the main objective of the present invention is to establish a post-energized metal-to-metal seal between two rotating bodies (e.g. a rotary connection device: swivel).

It is important to note that the “swivel” is a mechanical device from which the weight of the drill string is suspended. It is designed to allow the rotation of the drill string below, carrying large volumes of high-pressure drilling mud between the circulation system of the drilling equipment and the drill string. This device is specifically designed to facilitate subsea connections, allowing rotational installation until it is securely locked into its final position within the resident drilling equipment. Once the equipment is properly positioned, the rotary seal is activated, thereby ensuring an airtight seal between the bodies and preventing fluid leakage.

The prior art provides numerous technical solutions to the problem of designing a dynamic seal capable of providing efficient sealing under the extreme conditions found in oil installations, particularly subsea oil facilities. Examples of such technical solutions are the seals described in patents GB2569063 (A), GB2268559 (A), U.S. Pat. No. 5,044,672 (A), among others.

However, the seals offered by the prior art are complex, difficult to manufacture, or costly, and in many cases, they are inefficient in terms of their scaling capability.

Therefore, there still remains a need in the prior art for dynamic seals with a simple configuration that are capable of providing an efficient seal, with low manufacturing costs and easy to install while providing means to control the sealing efficiency thereof.

Such objectives are achieved with the seal of the present invention, which incorporates the concept of spherical contact using ball valve technology applied to rotating bodies. This approach offers several advantages, including simple configuration, reduced manufacturing and installation costs, shorter processing times for calculations and finite element analysis (FEA), which ultimately also lead to lower operational costs for failure detection throughout the product service life.

### SUMMARY OF THE INVENTION

The present invention provides a dynamic seal comprising an annular main body comprising an axial axis, an external peripheral surface and an internal peripheral surface, said internal peripheral surface comprising at least two convex contact surfaces configured to define a metal-to-metal sealing region, and wherein the external surface comprises at least two concave surfaces attached to the respective convex contact surfaces, separated by a flange projecting radially outward from the axial axis of said annular main body.

### BRIEF DESCRIPTION OF THE FIGURES

FIG. 1 shows a perspective view of the dynamic seal according to the present invention.

FIG. 2 shows a perspective view of the axial section 2-2 according to FIG. 1.

FIG. 3 shows a plan view of the axial section 2-2 according to FIG. 1 showing in detail the convex contact surfaces of seal D in contact with the cylindrical surfaces of rotating elements B to form a metal-to-metal sealing region.

FIG. 4 shows a longitudinal cross-sectional view of the sealing system with the dynamic seal (A) already installed within the seal housing and in contact with a rotating element (B).

### DETAILED DESCRIPTION OF THE INVENTION

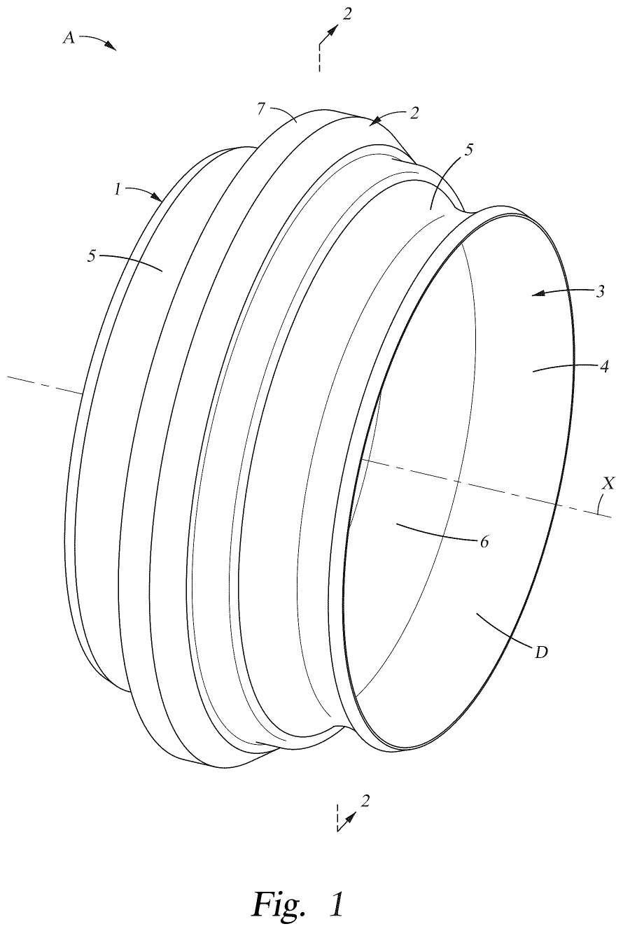

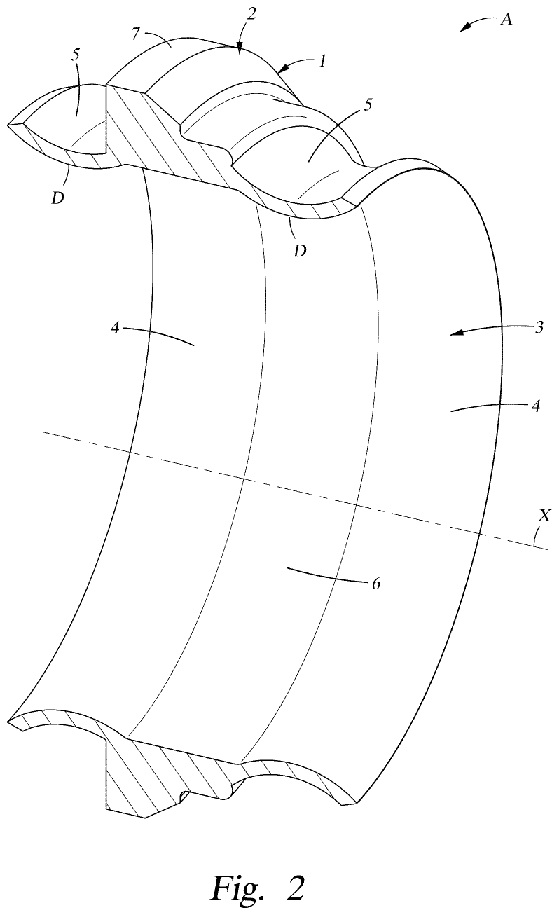

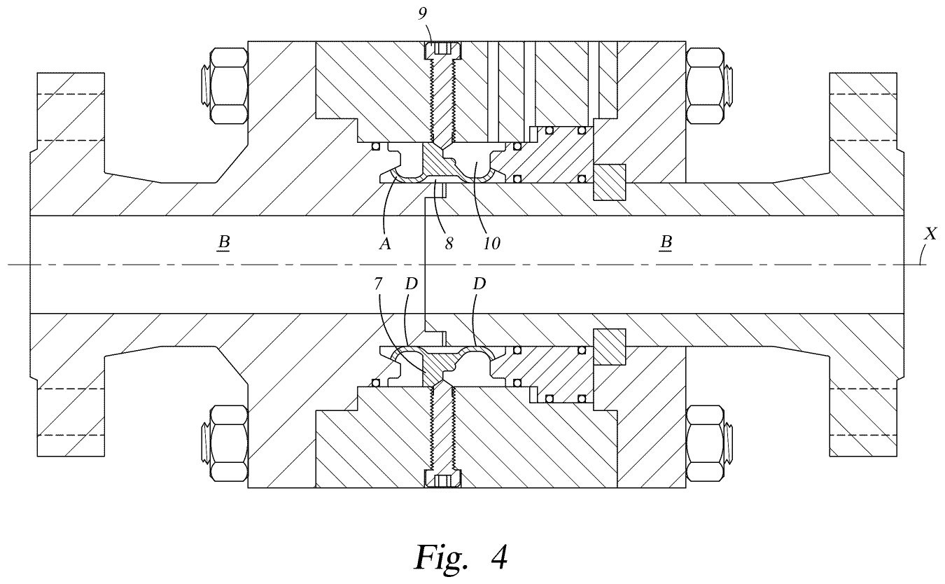

According to the present invention and as illustrated in FIGS. 1 to 4, the metallic dynamic seal (A) of the present invention comprises an annular main body 1 comprising an axial axis X, an external peripheral surface 2 and an internal peripheral surface 3, said internal peripheral surface 3 comprising at least two convex contact surfaces 4 configured to define a metal-to-metal sealing region D with the respective cylindrical surfaces provided by two rotating elements (FIG. 4: swivel B) passing through the annular main body 1 of the seal when it is installed in the drilling equipment of a drilling well. The external surface 2 comprises at least two concave surfaces 5 corresponding to said respective convex contact surfaces 4, wherein both concave surfaces 5 are separated by a flange 7 that projects radially outward from the axial axis X of said annular main body 1 and extends around the entire perimeter of the external peripheral surface 2. Said flange serves to anchor seal A in its final position once the seal is housed within the space defined by seal housing 10. Said anchoring of seal A is achieved by contact of said flange 7 with a locking element 9 and a flanged joint as shown in FIG. 4.

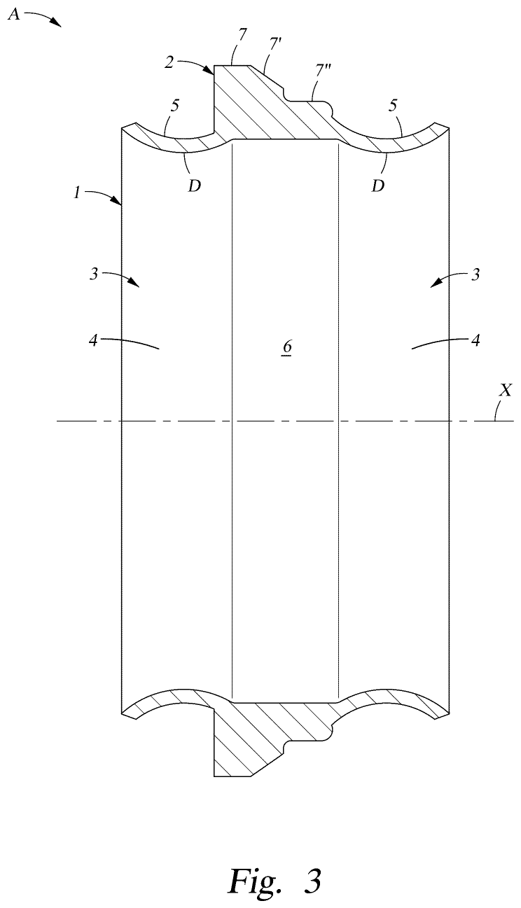

Preferably, flange 7 has an inclined face 7′ that connects to one of the concave surfaces 5 of the external peripheral surface 2 by means of an intermediate surface 7″, as shown in FIG. 3.

This inclined face 7′ and the intermediate surface 7″ cooperate to receive the locking element 9, which serves as a seal positioning component and prevents it from moving out of the original position thereof.

In another preferred embodiment of the invention, the dynamic seal has two convex contact surfaces 4 parallel to each other on the inner peripheral surface 3 thereof.

In another preferred embodiment, said two convex contact surfaces 4 are separated by an intermediate surface 6 so that when configuring a sealing region with the cylindrical surface of two rotating elements (swivel B), said convex contact surfaces and said intermediate region configure a sealing test chamber (8).

Preferably, the convex contact surfaces have a thickness ranging from 0.1 to 0.35 inches and, as indicated, provide a metal-to-metal sealing region when in contact with the cylindrical metal surface of respective rotating elements or swivels that pass through the annular body of the seal.

In a preferred embodiment of the invention, the surfaces that provide a metal-to-metal sealing region, that is, the region generated by the contact of the convex contact surfaces (4) of the dynamic seal and the cylindrical surfaces of the rotating elements (see FIG. 4 contact seal A-element B), are manufactured in a chromium-nickel alloy. Particularly, the chromium-nickel combination provides resistance to both reducing and oxidizing corrosive solutions. Nickel and chromium also work together to resist oxidation, carburization, and other forms of degradation at high temperatures. These alloys do not become brittle at cryogenic temperatures, exhibit good tensile and fatigue strength at moderate temperatures, and possess excellent flow and fracture resistance at high temperatures.

Preferably, the chromium-nickel alloy may contain other elements to improve the inherent characteristics thereof, for example, strength is improved by the addition of aluminum, titanium, and niobium (columbium). Other alloys contain cobalt, copper, molybdenum, or tungsten to improve specific mechanical or corrosion resistance attributes. The alloys also contain iron in amounts ranging from 1% to over 20%. In most cases, the dominant effects on properties are due to the alloying elements, except for iron. Chromium-nickel alloys, more particularly chromium-nickel allows sold under the Inconel® (a trademark of Special Metals Corporation), particularly Inconel® 600, 601, 617, 625, 690, 706, 713C, 718, 738, X-750, 751, 792, 907, 909, 925 or 939, preferably Inconel® 718 or 625.

In another embodiment of the invention, the convex contact surfaces may be coated with silver to prevent seizing.

The contact between the convex contact surfaces 4 and the cylindrical surfaces involves slight interference due to their final dimensions.

This interference will generate contact stress, ensuring a sealing effect at each contact point.

The seal is required to withstand structural loads and nominal internal liquid or gas pressures of up to 10,000 psi.

The contact between the convex contact surfaces 4 of the inner wall of the dynamic seal together with the intermediate surface 6 configure with the cylindrical surfaces of rotating elements (swivel B) a sealed chamber capable of receiving fluid from the external environment, effectively serving as a sealing test chamber 8.

1. A metallic dynamic seal (A), comprising:
an annular main body (1) comprising an axial axis (X), an external peripheral surface (2) and an internal peripheral surface (3), said internal peripheral surface (3) comprising at least two convex contact surfaces (4) configured to define a metal-to-metal sealing region, and wherein the external surface (2) comprises a flange (7) projecting radially outward from the axial axis (X) of said annular main body (1).

2. The metallic dynamic seal (A) according to claim 1, characterized in that said external peripheral surface (2) comprises at least two concave surfaces (5) separated from each other by said flange (7).

3. The metallic dynamic seal (A) according to claim 2, characterized in that said flange (7) has an inclined face (7″) that is connected to one of the concave surfaces (5) of the external peripheral surface (2) by means of an intermediate surface (7″).

4. The metallic dynamic seal (A) according to claim 2, characterized in that said two concave surfaces (5) extend around the entire perimeter of the external peripheral surface (2).

5. The metallic dynamic seal (A) according to claim 1, characterized in that the two convex contact surfaces (4) are parallel to each other.

6. The metallic dynamic seal (A) according to claim 2, characterized in that the two convex surfaces (5) are parallel to each other.

7. The metallic dynamic seal (A) according to claim 1, characterized in that said two convex contact surfaces (4) are separated by an intermediate surface (6).

8. The metallic dynamic seal (A) according to claim 1, characterized in that the convex contact surfaces (4) each have a thickness ranging from 0.1 to 0.35 inches (0.254 cm to 0.889 cm).

9. The metallic dynamic seal (A) according to claim 1, characterized in that the convex contact surfaces (4) are made of a chromium-nickel alloy.

10. The metallic dynamic seal (A) according to claim 9, characterized in that the convex contact surfaces (4) are additionally coated with silver.

11. The metallic dynamic seal (A) according to claim 1, characterized in that the convex contact surfaces (4) and the intermediate surface (6) form a sealing test chamber (8).
